(19) United States
(12) Patent Application Publication
(10) Pub. No.: US 2026/0050508 A1
(43) Pub. Date: Feb. 19, 2026

(54) PROVIDING PROCESSOR CORE FAULT RECOVERY WITHOUT REQUIRING SYSTEM RESETS IN MULTICORE PROCESSOR-BASED DEVICES

(71) Applicant: QUALCOMM Incorporated, San Diego, CA (US)

(72) Inventors: Dinesh Kumar Choudhary, Tonk (IN); Maulik Shah, Hyderabad (IN)

(21) Appl. No.: 18/808,903

(22) Filed: Aug. 19, 2024

(51) Int. Cl. G06F 11/07; G06F 9/48

(52) U.S. Cl. CPC G06F 11/0793; G06F 9/4401; G06F 9/4403; G06F 9/4405; G06F 9/4812; G06F 9/4856; G06F 9/4881; G06F 11/0721; G06F 11/1417; G06F 11/18; G06F 11/181; G06F 11/202; G06F 11/2028; G06F 11/2236; G06F 11/2242; G06F 11/2284; G06F 2201/805

(57) ABSTRACT

Providing processor core fault recovery without requiring system resets in multicore processor-based devices is disclosed herein. In some aspects, a processor-based device provides a plurality of processor cores that comprise a first processor core and a second processor core, with the first processor core configured to operate as a bootstrap processor core (BSP). The first processor core is configured to receive an interrupt corresponding to a registered timer event from a timer peripheral circuit, and, responsive to receiving the interrupt, transmit an interprocess interrupt (IPI) to the second processor core. The first processor core then determines whether a status update was successfully received from the second processor core in response to the IPI. If not, the first processor core performs one or more migration operations on the second processor core, masks the second processor core as offline for scheduling purposes, and blocks the second processor core from further health monitoring.

### TECHNICAL FIELD

The technology of the disclosure relates generally to processor core fault recovery by a processor device, and, in particular, to recovery from processor core faults in multicore processor-based devices.

### BACKGROUND

Conventional processor devices may be implemented as multiple processing units, or “processor cores,” that can be organized into core clusters. Each processor core is configured to independently fetch, decode, and execute computer instructions to manipulate and store data. Because such multicore processor devices can execute instructions on multiple processor cores simultaneously, the performance of software that supports parallel computing techniques such as multithreading may be improved when executing on such devices.

To optimize performance and ensure reliable operation, conventional multicore processor devices such as System-on-Chips (SoCs) may include a health monitoring circuit that is configured to periodically check the operating status of each processor core. In exemplary operation, one of the processor cores, designated as a bootstrap processor core (BSP), registers a timer event using a timer peripheral device, and starts a timer of the health monitoring circuit. When the timer expires, the timer event triggers the timer peripheral device to generate an interrupt to the BSP. The BSP then generates an interprocess interrupt (IPI) to each of the other active processor cores, and awaits a response from each. Each of the other active processor cores processes its respective received IPI, and, if in an active and healthy state, transmits a status update to the BSP. If the BSP receives status updates from all other active cores, it registers a new timer event using the timer peripheral device, and restarts the timer of the health monitoring circuit to begin a next health monitoring cycle. However, if one or more of the other processor cores fails to respond to respective IPIs from the BSP, the health monitoring circuit generates an interrupt to the BSP that causes the BSP to save the current context of the processor device and initiate a system-wide reset of the processor device.

While such conventional health monitoring mechanisms can allow the processor device to effectively recover from processor core faults, the need to perform a system-wide reset of the processor device when a single processor core fails can result in device instability and a suboptimal end-user experience. Accordingly, a mechanism for providing fault recovery without requiring a system reset is desirable.

### SUMMARY OF THE DISCLOSURE

Aspects disclosed in the detailed description include providing processor core fault recovery without requiring system resets in multicore processor-based devices. Related apparatus, methods, and computer-readable media are also disclosed. In this regard, in some exemplary aspects disclosed herein, a processor-based device includes a plurality of processor cores, where a first processor core of the plurality of processor cores is configured to operate as a bootstrap processor core (BSP). In exemplary operation, the first processor core receives an interrupt corresponding to a registered timer event from a timer peripheral circuit of the processor-based device. In response to receiving the interrupt, the first processor core transmits an interprocess interrupt (IPI) to a second processor core of the plurality of processor cores. The first processor core then determines whether a status update was successfully received from the second processor core in response to the IPI. If not, the first processor core performs one or more migration operations (e.g., migrating one or more of a task, a work item, and an interrupt from the second processor core to a third processor core of the plurality of processor cores, as non-limiting examples) on the second processor core. The first processor core also masks the second processor core as offline for scheduling purposes, and blocks the second processor core from further health monitoring. In some aspects, the first processor core registers a next timer event with the timer peripheral circuit, and then restarts a timer of the health monitoring circuit. In this manner, the overall stability of the processor-based device, along with the robustness of the end-user experience, is improved by avoiding abrupt system resets, while having only minimal impact on processor power consumption.

In some aspects, if the first processor core determines that no status update was successfully received from the second processor core in response to the IPI, the first processor core may further determine whether a count of remaining active processor cores is below a minimum threshold. If so, the first processor core may conclude that there exists an insufficient number of active processor cores to continue operation of the processor-based device. Consequently, the first processor core in such aspects saves a current context for the processor-based device, and triggers a system reset of the processor-based device.

Some aspects may further provide that the processor-based device is configured to recover the second processor core (e.g., at the expiration of a time interval, or in response to a user input, as non-limiting examples). In some such aspects, operations for recovering the second processor core may comprise the processor-based device performing a system reset of the processor-based device, or entering a low-power mode (LPM).

In another aspect, a processor-based device is disclosed. The processor-based device comprises a plurality of processor cores that comprise a first processor core and a second processor core, wherein the first processor core is configured to operate as a BSP. The first processor core is configured to receive an interrupt corresponding to a registered timer event from a timer peripheral circuit. The first processor core is further configured to, responsive to receiving the interrupt, transmit an IPI to the second processor core. The first processor core is also configured to determine whether a status update was successfully received from the second processor core in response to the IPI. The first processor core is additionally configured to, responsive to determining that a status update was not successfully received from the second processor core, perform one or more migration operations on the second processor core. The first processor core is further configured to mask the second processor core as offline for scheduling purposes. The first processor core is also configured to block the second processor core from further health monitoring.

In another aspect, a processor-based device is disclosed. The processor-based device comprises means for receiving an interrupt corresponding to a registered timer event from a timer peripheral circuit. The processor-based device further comprises means for transmitting an IPI to a processor core of a plurality of processor cores of the processor-based device, responsive to receiving the interrupt. The processor-based device also comprises means for determining whether a status update was successfully received from the processor core in response to the IPI. The processor-based device additionally comprises means for performing one or more migration operations on the processor core, responsive to determining that a status update was not successfully received from the processor core. The processor-based device further comprises means for masking the processor core as offline for scheduling purposes, further responsive to determining that a status update was not successfully received from the processor core. The processor-based device also comprises means for blocking the second processor core from further health monitoring, further responsive to determining that a status update was not successfully received from the processor core.

In another aspect, a method for providing processor core fault recovery without requiring system resets in multicore processor-based devices is disclosed. The method comprises receiving, by a first processor core, configured to operate as a BSP, of a plurality of processor cores of a processor-based device, an interrupt corresponding to a registered timer event from a timer peripheral circuit. The method further comprises, responsive to receiving the interrupt, transmitting, by the first processor core, an IPI to a second processor core of the plurality of processor cores. The method also comprises determining, by the first processor core, that a status update was not successfully received from the second processor core in response to the IPI. The method additionally comprises, responsive to determining that a status update was not successfully received from the second processor core, performing, by the first processor core, one or more migration operations on the second processor core. The method further comprises masking, by the first processor core, the second processor core as offline for scheduling purposes. The method also comprises blocking, by the first processor core, the second processor core from further health monitoring.

In another aspect, a non-transitory computer-readable medium is disclosed. The non-transitory computer-readable medium stores computer-executable instructions that, when executed, cause a processor device of a processor-based device to receive an interrupt corresponding to a registered timer event from a timer peripheral circuit. The computer-executable instructions further cause the processor device to transmit an IPI to a processor core of a plurality of processor cores of the processor device, responsive to receiving the interrupt. The computer-executable instructions also cause the processor device to determine whether a status update was successfully received from the processor core in response to the IPI. The computer-executable instructions additionally cause the processor device to, responsive to determining that a status update was not successfully received from the processor core, perform one or more migration operations on the processor core. The computer-executable instructions further cause the processor device to mask the processor core as offline for scheduling purposes. The computer-executable instructions also cause the processor device to block the second processor core from further health monitoring.

### BRIEF DESCRIPTION OF THE FIGURES

FIG. 1 is a block diagram of an exemplary processor-based device including a processor core configured to provide processor core fault recovery without requiring system resets, according to some aspects;

FIGS. 2A-2C provide a flowchart illustrating exemplary operations of the processor core of FIG. 1 for providing processor core fault recovery without requiring system resets, according to some aspects; and FIG. 3 is a block diagram of an exemplary processor-based device that can include the processor core of FIG. 1.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects. The terms “first,” “second,” and the like used herein are intended to distinguish between similarly named elements, and do not indicate an ordinal relationship between such elements unless otherwise expressly indicated.

Aspects disclosed in the detailed description include providing processor core fault recovery without requiring system resets in multicore processor-based devices. Related apparatus, methods, and computer-readable media are also disclosed. In this regard, in some exemplary aspects disclosed herein, a processor-based device includes a plurality of processor cores, where a first processor core of the plurality of processor cores is configured to operate as a bootstrap processor core (BSP). In exemplary operation, the first processor core receives an interrupt corresponding to a registered timer event from a timer peripheral circuit of the processor-based device. In response to receiving the interrupt, the first processor core transmits an interprocess interrupt (IPI) to a second processor core of the plurality of processor cores. The first processor core then determines whether a status update was successfully received from the second processor core in response to the IPI. If not, the first processor core performs one or more migration operations (e.g., migrating one or more of a task, a work item, and an interrupt from the second processor core to a third processor core of the plurality of processor cores, as non-limiting examples) on the second processor core. The first processor core also masks the second processor core as offline for scheduling purposes, and blocks the second processor core from further health monitoring. In some aspects, the first processor core registers a next timer event with the timer peripheral circuit, and then restarts a timer of the health monitoring circuit. In this manner, the overall stability of the processor-based device, along with the robustness of the end-user experience, is improved by avoiding abrupt system resets, while having only minimal impact on processor power consumption.

In some aspects, if the first processor core determines that no status update was successfully received from the second processor core in response to the IPI, the first processor core may further determine whether a count of remaining active processor cores is below a minimum threshold. If so, the first processor core may conclude that there exists an insufficient number of active processor cores to continue operation of the processor-based device. Consequently, the first processor core in such aspects saves a current context for the processor-based device, and triggers a system reset of the processor-based device.

Some aspects may further provide that the processor-based device is configured to recover the second processor core (e.g., at the expiration of a time interval, or in response to a user input, as non-limiting examples). In some such aspects, operations for recovering the second processor core may comprise the processor-based device performing a system reset of the processor-based device, or entering a low-power mode (LPM).

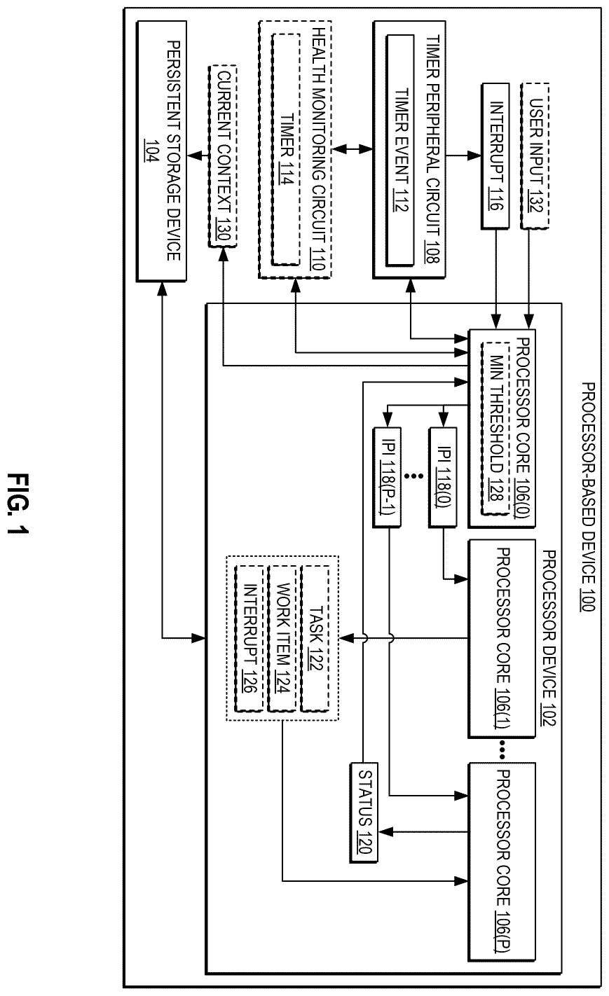

In this regard, FIG. 1 is a diagram of an exemplary processor-based device 100 that includes a processor device 102 configured to provide processor core fault recovery without requiring system resets. In some aspects, the processor device 102 may comprise a System-on-Chip (SoC). The processor device 102 according to some aspects may be an in-order or an out-of-order processor (OoP), and/or may be one of a plurality of processor devices 102 provided by the processor-based device 100. The processor device 102 in the example of FIG. 1 is communicatively coupled to a persistent storage device 104, which may comprise, e.g., a hard drive or flash drive, as non-limiting examples.

The processor device 102 includes a plurality of processor cores 106(0)-106(P) that each are configured to independently fetch, decode, and execute computer instructions (not shown) in parallel. The processor cores 106(0)-106(P) are communicatively coupled to each other and to other elements of the processor device 102 and the processor-based device 100 via one or more communications buses (not shown). In the example of FIG. 1, the processor core 106(0) is designated as a BSP, and thus is configured to initialize and configure the other processor cores 106(1)-106(P) (also referred to as “application processors” or “APs”) of the processor device 102. For instance, the processor core 106(0) may be responsible for setting up system parameters and configurations, loading operating systems, and starting up the other processor cores 106(1)-106(P).

The processor-based device 100 of FIG. 1 may encompass any one of known digital logic elements, semiconductor circuits, processing cores, and/or memory structures, among other elements, or combinations thereof. Aspects described herein are not restricted to any particular arrangement of elements, and the disclosed techniques may be easily extended to various structures and layouts on semiconductor dies or packages. It is to be understood that some aspects of the processor-based device 100, the processor device 102, and/or the processor cores 106(0)-106(P) may include elements in addition to or instead of those illustrated in FIG. 1, and/or may include more or fewer of the elements illustrated in FIG. 1. For example, the processor-based device 100 may further include caches, controllers, communications buses, and/or persistent storage devices, which are omitted from FIG. 1 for the sake of clarity.

To optimize performance and ensure reliable operation of the processor device 102, the processor-based device 100 includes a timer peripheral circuit 108 and, in some aspects, a health monitoring circuit 110, for assessing the health of the processor cores 106(0)-106(P) and, if necessary, recovering functionality of the processor-based device 100 in the event of a processor core fault. In conventional operation as described above, the timer peripheral circuit 108 and the health monitoring circuit 110 may enable the processor device 102 to recover from a fault in one or more of the processor cores 106(0)-106(P) by performing a system reset of the processor-based device 100. However, such a full system reset can result in instability of the processor-based device 100 and a suboptimal end-user experience.

Accordingly, the processor core 106(0) acting as the BSP of the processor device 102 is configured to provide fault recovery without requiring a full system reset. In exemplary operation, the processor core 106(0) registers a timer event 112 with the timer peripheral circuit 108, where the timer event 112 is set to be triggered by expiration of a timer 114 of the health monitoring circuit 110. The timer 114 is then started by the health monitoring circuit 110. Upon expiration of the timer 114 and the triggering of the timer event 112, the timer peripheral circuit 108 generates an interrupt 116, and transmits the interrupt 116 to the processor core 106(0). Upon receiving the interrupt 116, the processor core 106(0) generates and transmits IPIs 118(0)-118(P-1) to each of the other active processor cores 106(1)-106(P) (note that, at the point in time illustrated in FIG. 1, all of the processor cores 106(0)-106(P) are assumed to be active). The processor core 106(0) then waits to receive a status update from each of the processor cores 106(0)-106(P). In the example of FIG. 1, the processor core 106(P) transmits a status update 120 (captioned as “STATUS” in FIG. 1) to the processor core 106(0) to indicate that the processor core 106(P) is in a healthy state and is functioning normally. In this example, though, the processor core 106(1) has experienced a fault condition, and consequently is unable to transmit a status update to the processor core 106(0).

The processor core 106(0) subsequently determines whether a status update, such as the status update 120, was successfully received from each of the processor cores 106(1)-106(P) in response to the corresponding IPIs 118(0)-118(P-1). In this example, the processor core 106(0) determines that no status update was received from the processor core 106(1). The first processor core 106(0) thus concludes that the processor core 106(1) has suffered a fault, and, in response, performs one or more migration operations on the processor core 106(1). In some aspects, the operations for performing the one or more migration operations may include the processor core 106(0) migrating one or more of a task 122, a work item 124, and an interrupt 126 from the processor core 106(1) to another processor core, such as the processor core 106(P). In this manner, the task 122, the work item 124, and the interrupt 126 are transferred to the processor core 106(P) for handling in the future. The processor core 106(0) then masks the processor core 106(1) as offline for scheduling purposes (i.e., so that the processor device 102 no longer schedules any processes for execution by the processor core 106(1)). Finally, the processor core 106(0) blocks the processor core 106(1) from further health monitoring (e.g., to avoid the processing overhead of sending an IPI to the processor core 106(0) and waiting for a responsive status update in the future).

The processor core 106(0) in some aspects may then restart a next health monitoring cycle by registering a next timer event 112 with the timer peripheral circuit 108, and restarting the timer 114 of the health monitoring circuit 110. Upon the next expiration of the timer 114, the health monitoring circuit 110 triggers the timer event 112 again, which causes the operations of the timer peripheral circuit 108 and the processor core 106(0) described above to repeat.

In some aspects, the processor core 106(0) may perform additional operations to determine whether a sufficient number of the processor cores 106(1)-106(P) remain active to sustain operations of the processor-based device 100. Accordingly, such aspects may provide that, if the processor core 106(0) determines that no status update was successfully received from the processor core 106(1) in response to the IPI 118(0), the processor core 106(0) may further determine whether a count of remaining active processor cores 106(2)-106(P) is below a minimum threshold 128 (captioned as “MIN THRESHOLD” in FIG. 1). If so, the processor core 106(0) saves (e.g., to the persistent storage device 104) a current context 130 for the processor-based device 100, where the current context 130 comprises data indicating a system state of the processor-based device 100 for use in restoring the processor-based device 100 to that system state following a system reset. The processor core 106(0) then triggers a system reset of the processor-based device 100.

According to some aspects, after a processor core such as the processor core 106(1) is determined to have faulted, the processor-based device 100 may subsequently perform operations to recover the processor core 106(1). Some such aspects may provide that recovering the second processor core 106(1) may comprise the processor-based device 100 performing a system reset of the processor-based device 100. The system reset may be performed, e.g., in response to a user input 132. In some such aspects, recovering the second processor core 106(1) may comprise the processor-based device 100 entering an LPM.

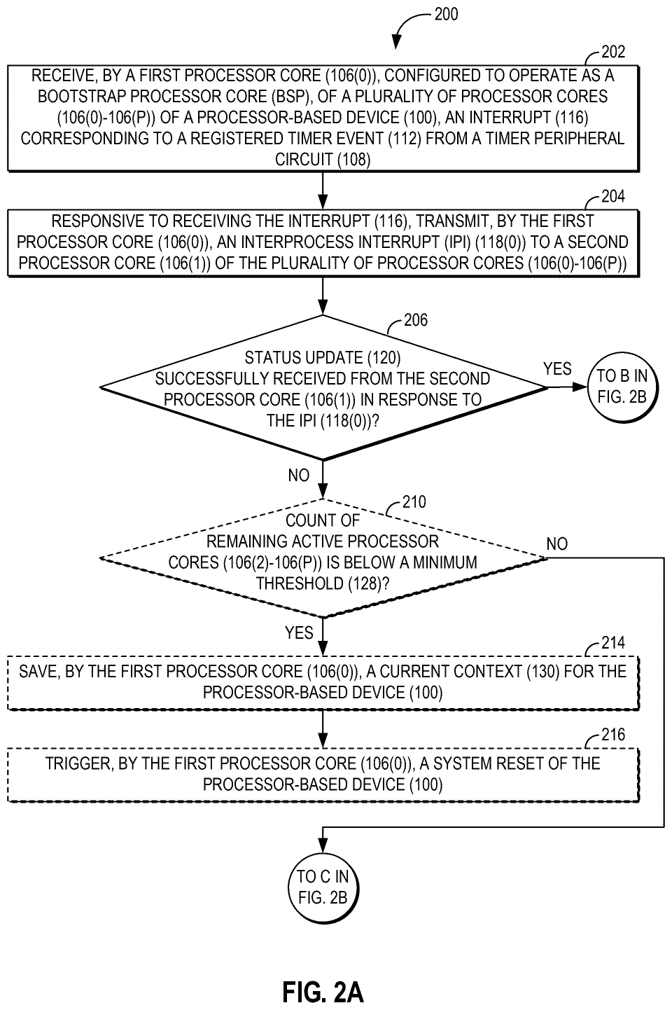

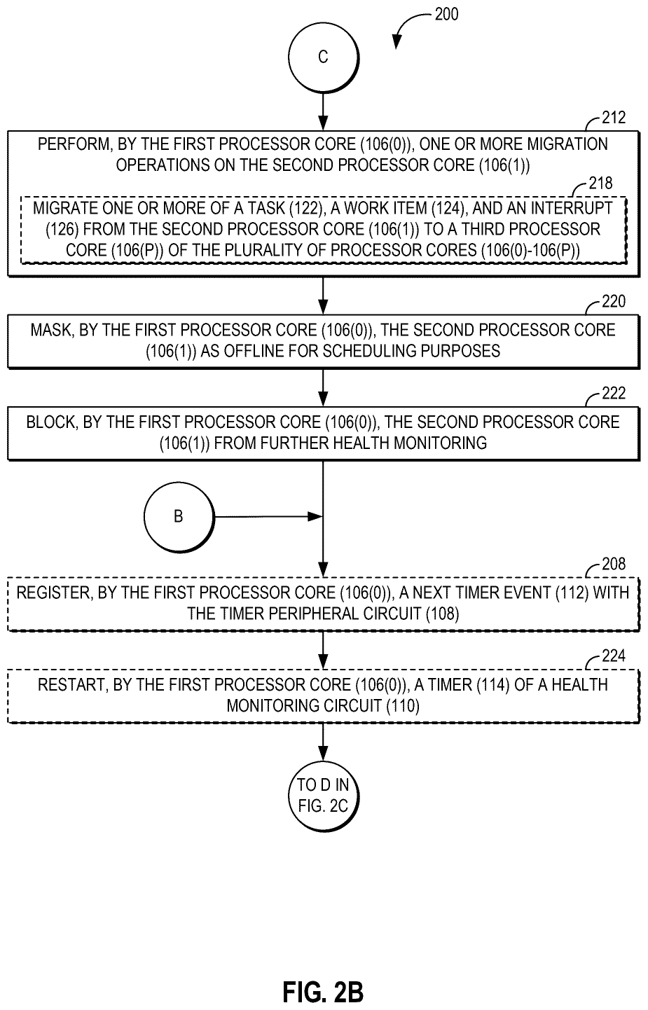

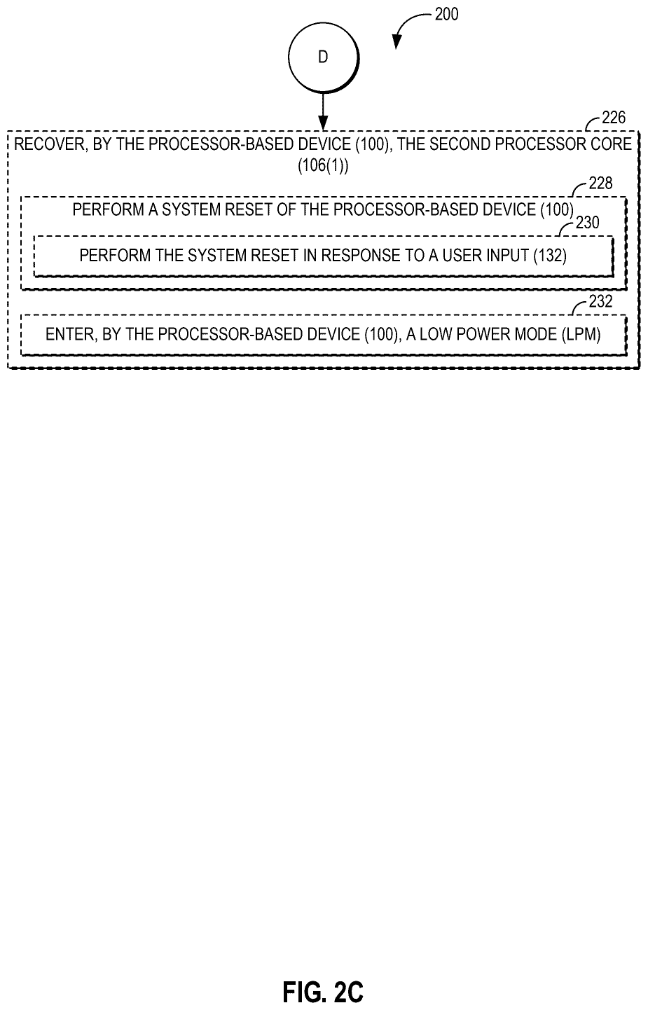

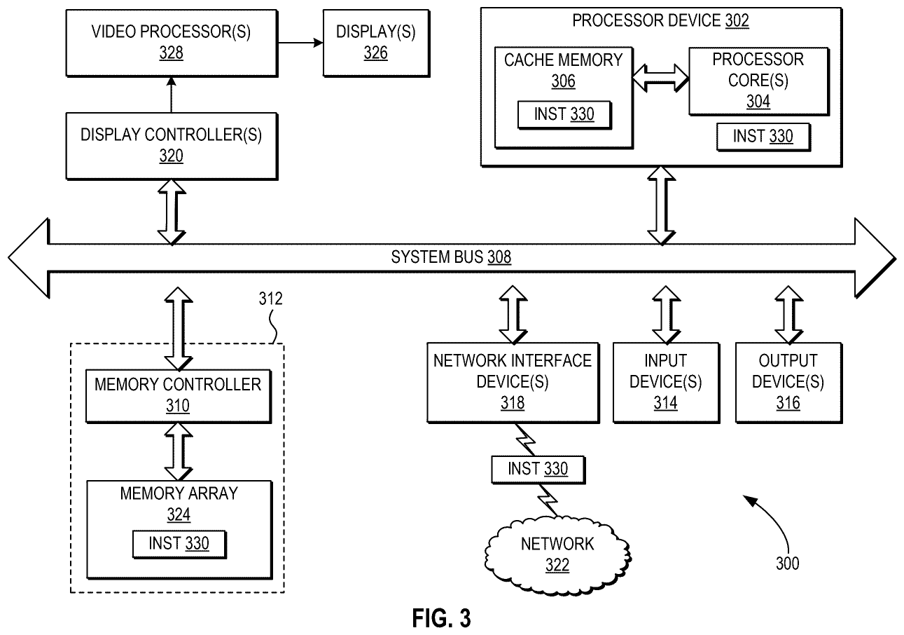

To illustrate operations performed by the processor core 106(0) of FIG. 1 for providing processor core fault recovery without requiring system resets according to some aspects, FIGS. 2A-2C provide a flowchart showing exemplary operations 200. For the sake of clarity, elements of FIG. 1 are referenced in describing FIGS. 2A-2C. It is to be understood that some aspects may provide that some operations illustrated in FIGS. 2A-2C may be performed in an order other than that illustrated herein, and/or may be omitted.

The exemplary operations 200 according to some aspects begin in FIG. 2A with a first processor core (e.g., the processor core 106(0) of FIG. 1), configured to operate as a BSP, of a plurality of processor cores (such as the processor cores 106(0)-106(P) of FIG. 1) of a processor-based device (e.g., the processor-based device 100 of FIG. 1), receiving an interrupt (such as the interrupt 116 of FIG. 1) corresponding to a registered timer event (e.g., the timer event 112 of FIG. 1) from a timer peripheral circuit (such as the timer peripheral circuit 108 of FIG. 1) (block 202). Responsive to receiving the interrupt 116, the first processor core 106(0) transmits an IPI (e.g., the IPI 118(0) of FIG. 1) to a second processor core (such as the processor core 106(1) of FIG. 1) of the plurality of processor cores 106(0)-106(P) (block 204).

The first processor core 106(0) then determines whether a status update (e.g., the status update 120 of FIG. 1) was successfully received from the second processor core 106(1) in response to the IPI 118(0) (block 206). If so, the exemplary operations 200 continue at block 208 of FIG. 2B. However, if the first processor core 106(0) determines at decision block 206 that no status update was successfully received from the second processor core 106(1) in response to the IPI 118(0), the first processor core 106(0) in some aspects may further determine whether a count of remaining active processor cores 106(2)-106(P) is below a minimum threshold (such as the minimum threshold 128 of FIG. 1) (block 210). If not, the exemplary operations 200 may continue at block 212 of FIG. 2B. If the first processor core 106(0) determines at decision block 210 that the count of the remaining active processor cores 106(2)-106(P) is below the minimum threshold 128, the first processor core 106(0) may save a current context (e.g., the current context 130 of FIG. 1) for the processor-based device 100 (block 214). The first processor core 106(0) may then trigger a system reset of the processor-based device 100 (block 216). In aspects in which the first processor core 106(0) does not perform the operations of decision block 210, and/or if the first processor core 106(0) determines at decision block 210 that the count of the remaining active processor cores 106(2)-106(P) is not below the minimum threshold 128, the exemplary operations 200 continue at block 212 of FIG. 2B.

Turning now to FIG. 2B, the first processor core 106(0) performs one or more migration operations on the second processor core 106(1) (block 212). In some aspects, the operations of block 212 for performing the one or more migration operations may comprise the first processor core 106(0) migrating one or more of a task (such as the task 122 of FIG. 1), a work item (e.g., the work item 124 of FIG. 1), and an interrupt (such as the interrupt 126 of FIG. 1) from the second processor core 106(1) to a third processor core (e.g., the processor core 106(P) of FIG. 1) of the plurality of processor cores 106(0)-106(P) (block 218). The first processor core 106(0) also masks the second processor core 106(1) as offline for scheduling purposes (block 220). The first processor core 106(0) additionally blocks the second processor core 106(1) from further health monitoring (block 222). Some aspects may provide that the first processor core 106(0) then registers a next timer event 112 with the timer peripheral circuit 108 (block 208). The first processor core 106(0) is such aspects then restarts a timer (such as the timer 114 of FIG. 1) of a health monitoring circuit (such as the health monitoring circuit 110 of FIG. 1) (block 224). The exemplary operations 200 in some aspects may continue at block 226 of FIG. 2C.

Referring now to FIG. 2C, the processor-based device 100 according to some aspects is configured to recover the second processor core 106(1) (block 226). Some such aspects may provide that the operations of block 226 for recovering the second processor core 106(1) may comprise the processor-based device 100 performing a system reset of the processor-based device 100 (block 228). According to some such aspects, the operations of block 228 for performing the system reset of the processor-based device 100 are performed in response to a user input (such as the user input 132 of FIG. 1) (block 230). In some such aspects, the operations of block 226 for recovering the second processor core 106(1) may comprise the processor-based device 100 entering an LPM (block 232).

The instruction processing circuit according to aspects disclosed herein and discussed with reference to FIGS. 1 and 2A-2C may be provided in or integrated into any processor-based device. Examples, without limitation, include a set top box, an entertainment unit, a navigation device, a communications device, a fixed location data unit, a mobile location data unit, a global positioning system (GPS) device, a mobile phone, a cellular phone, a smart phone, a session initiation protocol (SIP) phone, a tablet, a phablet, a server, a computer, a portable computer, a mobile computing device, laptop computer, a wearable computing device (e.g., a smart watch, a health or fitness tracker, eyewear, etc.), a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, and a vehicle component.

In this regard, FIG. 3 illustrates an example of a processor-based device 300, which corresponds in functionality to the processor-based device 100 of FIG. 1. In this example, the processor-based device 300 includes a processor device 302 that comprises one or more processor cores 304 (corresponding to the processor cores 106(0)-106(P) of FIG. 1) coupled to a cache memory 306. The processor device 302 is also coupled to a system bus 308 and can intercouple devices included in the processor-based device 300. As is well known, the processor device 302 communicates with these other devices by exchanging address, control, and data information over the system bus 308. For example, the processor device 302 can communicate bus transaction requests to a memory controller 310. Although not illustrated in FIG. 3, multiple system buses 308 could be provided, wherein each system bus 308 constitutes a different fabric.

Other devices may be connected to the system bus 308. As illustrated in FIG. 3, these devices can include a memory system 312, one or more input devices 314, one or more output devices 316, one or more network interface devices 318, and one or more display controllers 320, as examples. The input device(s) 314 can include any type of input device, including, but not limited to, input keys, switches, voice processors, etc. The output device(s) 316 can include any type of output device, including, but not limited to, audio, video, other visual indicators, etc. The network interface device(s) 318 can be any devices configured to allow exchange of data to and from a network 322. The network 322 can be any type of network, including, but not limited to, a wired or wireless network, a private or public network, a local area network (LAN), a wireless local area network (WLAN), a wide area network (WAN), a BLUETOOTH™ network, and the Internet. The network interface device(s) 318 can be configured to support any type of communications protocol desired. The memory system 312 can include the memory controller 310 coupled to one or more memory arrays 324.

The processor device 302 may also be configured to access the display controller(s) 320 over the system bus 308 to control information sent to one or more displays 326. The display controller(s) 320 sends information to the display(s) 326 to be displayed via one or more video processors 328, which process the information to be displayed into a format suitable for the display(s) 326. The display(s) 326 can include any type of display, including, but not limited to, a cathode ray tube (CRT), a liquid crystal display (LCD), a plasma display, a light emitting diode (LED) display, etc.

The processor-based device 300 in FIG. 3 may include a set of instructions 330 (captioned as “INST” in FIG. 3) that may be executed by the processor device 302 for any application desired according to the instructions. The instructions 330 may be stored in the memory system 312, the processor device 302, and/or the cache memory 306, each of which may comprise an example of a non-transitory computer-readable medium. The instructions 330 may also reside, completely or at least partially, within the memory system 312 and/or within the processor device 302 during their execution. The instructions 330 may further be transmitted or received over the network 322, such that the network 322 may comprise an example of a computer-readable medium.

While the computer-readable medium is described in an exemplary embodiment herein to be a single medium, the term “computer-readable medium” should be taken to include a single medium or multiple media (e.g., a centralized or distributed database, and/or associated caches and servers) that store the set of instructions 330. The term “computer-readable medium” shall also be taken to include any medium that is capable of storing, encoding, or carrying a set of instructions for execution by a processing device and that cause the processing device to perform any one or more of the methodologies of the embodiments disclosed herein. The term “computer-readable medium” shall accordingly be taken to include, but not be limited to, solid-state memories, optical medium, and magnetic medium.

Those of skill in the art will further appreciate that the various illustrative logical blocks, modules, circuits, and algorithms described in connection with the aspects disclosed herein may be implemented as electronic hardware, instructions stored in memory or in another computer readable medium and executed by a processor or other processing device, or combinations of both. The master devices and slave devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations. Thus, the disclosure is not intended to be limited to the examples and designs described herein, but is to be accorded the widest scope consistent with the principles and novel features disclosed herein.

Implementation examples are described in the following numbered clauses:
1. A processor-based device, comprising:
   a plurality of processor cores, comprising a first processor core and a second processor core, wherein the first processor core is configured to operate as a bootstrap processor core (BSP);
   the first processor core configured to:
      receive an interrupt corresponding to a registered timer event from a timer peripheral circuit;
      responsive to receiving the interrupt, transmit an interprocess interrupt (IPI) to the second processor core;
      determine whether a status update was successfully received from the second processor core in response to the IPI; and
      responsive to determining that a status update was not successfully received from the second processor core:
         perform one or more migration operations on the second processor core;
         mask the second processor core as offline for scheduling purposes; and
         block the second processor core from further health monitoring.
2. The processor-based device of clause 1, wherein the first processor core is configured to perform the one or more migration operations by being configured to migrate one or more of a task, a work item, and an interrupt from the second processor core to a third processor core of the plurality of processor cores.
3. The processor-based device of any one of clauses 1-2, wherein the first processor core is further configured to:
   register a next timer event with the timer peripheral circuit; and
   restart a timer of a health monitoring circuit.
4. The processor-based device of clause 3, wherein the first processor core is configured to register the next timer event with the timer peripheral circuit and restart the timer of the health monitoring circuit responsive to determining that a status update was successfully received from the second processor core.
5. The processor-based device of any one of clauses 1-4, wherein the processor-based device is configured to recover the second processor core.
6. The processor-based device of clause 5, wherein the processor-based device is configured to recover the second processor core by performing a system reset of the processor-based device.
7. The processor-based device of clause 6, wherein the system reset is performed in response to a user input.
8. The processor-based device of clause 5, wherein the processor-based device is configured to recover the second processor core by entering a low power mode (LPM).
9. The processor-based device of any one of clauses 1-8, wherein the first processor core is further configured to, responsive to determining that no status update was received from the second processor core:
   determine whether a count of remaining active processor cores is below a minimum threshold; and
   responsive to determining that the count of the remaining active processor cores is below the minimum threshold:
      save a current context for the processor-based device; and
      trigger a system reset of the processor-based device;
   wherein the first processor core is configured to perform the one or more migration operations on the second processor core, mask the second processor core as offline for scheduling purposes, and block the second processor core from further health monitoring further responsive to determining that the count of the remaining active processor cores is not below the minimum threshold.
10. The processor-based device of any one of clauses 1-9, integrated into a device selected from the group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; and a vehicle component.
11. A processor-based device, comprising:
   means for receiving an interrupt corresponding to a registered timer event from a timer peripheral circuit;
   means for transmitting an interprocess interrupt (IPI) to a processor core of a plurality of processor cores of the processor-based device, responsive to receiving the interrupt;
   means for determining whether a status update was successfully received from the processor core in response to the IPI;
   means for performing one or more migration operations on the processor core, responsive to determining that a status update was not successfully received from the processor core;
   means for masking the processor core as offline for scheduling purposes, further responsive to determining that a status update was not successfully received from the processor core; and
   means for blocking the processor core from further health monitoring, further responsive to determining that a status update was not successfully received from the processor core.
12. A method for providing processor core fault recovery without requiring system resets in multicore processor-based devices, the method comprising:
   receiving, by a first processor core, configured to operate as a bootstrap processor core (BSP), of a plurality of processor cores of a processor-based device, an interrupt corresponding to a registered timer event from a timer peripheral circuit;
   responsive to receiving the interrupt, transmitting, by the first processor core, an interprocess interrupt (IPI) to a second processor core of the plurality of processor cores;
   determining, by the first processor core, that a status update was not successfully received from the second processor core in response to the IPI; and
   responsive to determining that a status update was not successfully received from the second processor core:
      performing, by the first processor core, one or more migration operations on the second processor core;
      masking, by the first processor core, the second processor core as offline for scheduling purposes; and
      blocking, by the first processor core, the second processor core from further health monitoring.
13. The method of clause 12, wherein performing the one or more migration operations comprises migrating one or more of a task, a work item, and an interrupt from the second processor core to a third processor core of the plurality of processor cores.
14. The method of any one of clauses 12-13, further comprising:
   registering, by the first processor core, a next timer event with the timer peripheral circuit; and
   restarting, by the first processor core, a timer of a health monitoring circuit.
15. The method of any one of clauses 12-14, further comprising recovering, by the processor-based device, the second processor core.
16. The method of clause 15, wherein recovering the second processor core comprises performing a system reset of the processor-based device.
17. The method of clause 16, comprising performing the system reset in response to a user input.
18. The method of clause 15, wherein recovering the second processor core comprises entering, by the processor-based device, a low power mode (LPM).
19. The method of any one of clauses 12-18, further comprising, responsive to determining that no status update was received from the second processor core:
   determining, by the first processor core, whether a count of remaining active processor cores is below a minimum threshold; and
   responsive to determining that the count of the remaining active processor cores is below the minimum threshold:
      saving, by the first processor core, a current context for the processor-based device; and
      triggering, by the first processor core, a system reset of the processor-based device.
20. A non-transitory computer-readable medium, having stored thereon computer-executable instructions that, when executed, cause a processor device to:
   receive an interrupt corresponding to a registered timer event from a timer peripheral circuit;
   transmit an interprocess interrupt (IPI) to a processor core of a plurality of processor cores of the processor device, responsive to receiving the interrupt;
   determine whether a status update was successfully received from the processor core in response to the IPI; and
   responsive to determining that a status update was not successfully received from the processor core:
      perform one or more migration operations on the processor core;
      mask the processor core as offline for scheduling purposes; and
      block the second processor core from further health monitoring.

1. A processor-based device, comprising:
a plurality of processor cores, comprising a first processor core and a second processor core, wherein the first processor core is configured to operate as a bootstrap processor core (BSP);
the first processor core configured to:
receive an interrupt corresponding to a registered timer event from a timer peripheral circuit;
responsive to receiving the interrupt, transmit an interprocess interrupt (IPI) to the second processor core;
determine whether a status update was successfully received from the second processor core in response to the IPI; and
responsive to determining that a status update was not successfully received from the second processor core:
perform one or more migration operations on the second processor core;
mask the second processor core as offline for scheduling purposes; and
block the second processor core from further health monitoring.

2. The processor-based device of claim 1, wherein the first processor core is configured to perform the one or more migration operations by being configured to migrate one or more of a task, a work item, and an interrupt from the second processor core to a third processor core of the plurality of processor cores.

3. The processor-based device of claim 1, wherein the first processor core is further configured to:
register a next timer event with the timer peripheral circuit; and
restart a timer of a health monitoring circuit.

4. The processor-based device of claim 3, wherein the first processor core is configured to register the next timer event with the timer peripheral circuit and restart the timer of the health monitoring circuit responsive to determining that a status update was successfully received from the second processor core.

5. The processor-based device of claim 1, wherein the processor-based device is configured to recover the second processor core.

6. The processor-based device of claim 5, wherein the processor-based device is configured to recover the second processor core by performing a system reset of the processor-based device.

7. The processor-based device of claim 6, wherein the system reset is performed in response to a user input.

8. The processor-based device of claim 5, wherein the processor-based device is configured to recover the second processor core by entering a low power mode (LPM).

9. The processor-based device of claim 1, wherein the first processor core is further configured to, responsive to determining that no status update was received from the second processor core:
determine whether a count of remaining active processor cores is below a minimum threshold; and
responsive to determining that the count of the remaining active processor cores is below the minimum threshold:
save a current context for the processor-based device; and
trigger a system reset of the processor-based device;
wherein the first processor core is configured to perform the one or more migration operations on the second processor core, mask the second processor core as offline for scheduling purposes, and block the second processor core from further health monitoring further responsive to determining that the count of the remaining active processor cores is not below the minimum threshold.

10. The processor-based device of claim 1, integrated into a device selected from the group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; and a vehicle component.

11. A processor-based device, comprising:
means for receiving an interrupt corresponding to a registered timer event from a timer peripheral circuit;
means for transmitting an interprocess interrupt (IPI) to a processor core of a plurality of processor cores of the processor-based device, responsive to receiving the interrupt;
means for determining whether a status update was successfully received from the processor core in response to the IPI;
means for performing one or more migration operations on the processor core, responsive to determining that a status update was not successfully received from the processor core;
means for masking the processor core as offline for scheduling purposes, further responsive to determining that a status update was not successfully received from the processor core; and
means for blocking the processor core from further health monitoring, further responsive to determining that a status update was not successfully received from the processor core.

12. A method for providing processor core fault recovery in multicore processor-based devices, the method comprising:
receiving, by a first processor core, configured to operate as a bootstrap processor core (BSP), of a plurality of processor cores of a processor-based device, an interrupt corresponding to a registered timer event from a timer peripheral circuit;
responsive to receiving the interrupt, transmitting, by the first processor core, an interprocess interrupt (IPI) to a second processor core of the plurality of processor cores;
determining, by the first processor core, that a status update was not successfully received from the second processor core in response to the IPI; and
responsive to determining that a status update was not successfully received from the second processor core:
performing, by the first processor core, one or more migration operations on the second processor core;
masking, by the first processor core, the second processor core as offline for scheduling purposes; and
blocking, by the first processor core, the second processor core from further health monitoring.

13. The method of claim 12, wherein performing the one or more migration operations comprises migrating one or more of a task, a work item, and an interrupt from the second processor core to a third processor core of the plurality of processor cores.

14. The method of claim 12, further comprising:
registering, by the first processor core, a next timer event with the timer peripheral circuit; and
restarting, by the first processor core, a timer of a health monitoring circuit.

15. The method of claim 12, further comprising recovering, by the processor-based device, the second processor core.

16. The method of claim 15, wherein recovering the second processor core comprises performing a system reset of the processor-based device.

17. The method of claim 16, comprising performing the system reset in response to a user input.

18. The method of claim 15, wherein recovering the second processor core comprises entering, by the processor-based device, a low power mode (LPM).

19. The method of claim 12, further comprising, responsive to determining that no status update was received from the second processor core:
determining, by the first processor core, whether a count of remaining active processor cores is below a minimum threshold; and
responsive to determining that the count of the remaining active processor cores is below the minimum threshold:
saving, by the first processor core, a current context for the processor-based device; and
triggering, by the first processor core, a system reset of the processor-based device.

20. A non-transitory computer-readable medium, having stored thereon computer-executable instructions that, when executed, cause a processor device to:
receive an interrupt corresponding to a registered timer event from a timer peripheral circuit;
transmit an interprocess interrupt (IPI) to a processor core of a plurality of processor cores of the processor device, responsive to receiving the interrupt;
determine whether a status update was successfully received from the processor core in response to the IPI; and
responsive to determining that a status update was not successfully received from the processor core:
perform one or more migration operations on the processor core;
mask the processor core as offline for scheduling purposes; and
block the second processor core from further health monitoring.
